(19) United States
(12) Patent Application Publication
(10) Pub. No.: US 2004/0124402 A1
(43) Pub. Date: Jul. 1, 2004

(54) Negative electrode material, and production method and use thereof

(75) Inventors: Youichi Nanba, Kanagawa (JP); Satoshi Iinou, Nagano (JP); Akinori Sudo, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K.

(21) Appl. No.: 10/737,931

(22) Filed: Dec. 18, 2003

Related U.S. Application Data
(60) Provisional application No. 60/436,639, filed on Dec. 30, 2002.

(30) Foreign Application Priority Data
Dec. 25, 2002 (JP) P2002-374271

(51) Int. Cl. H01B 1/00

(52) U.S. Cl. 252/500

(57) ABSTRACT

A negative electrode material comprising carbonaceous powder serving as a nucleus, and a carbon layer formed on the surface of the powder, characterized in that the carbon layer, when observed under a transmission electron microscope, has crystalline carbon regions and amorphous carbon regions in a bright-field image thereof, and that the ratio of the intensity of a peak at 1,360 cm⁻¹ in a laser Raman spectrum of the carbon layer to that of a peak at 1,580 cm⁻¹ in the spectrum is 0.3 or less. Also disclosed is a method for producing the negative electrode material, an electrode paste, an electrode, and a secondary battery including the electrode.

### CROSS-REFERENCE TO RELATED APPLICATIONS

This application claims benefit of Provisional Application No. 60/436,639 filed Dec. 30, 2002, incorporated herein by reference, under 35 U.S.C. § 111(b) pursuant to 35 U.S.C. § 119(e) (1).

### BACKGROUND OF THE INVENTION

1. Field of the Invention

The present invention relates to an electrode material for producing a non-aqueous electrolyte secondary battery having a high charging/discharging capacity, exhibiting excellent charging/discharging cycle characteristics, and exhibiting excellent high current loading characteristics. The present invention also relates to an electrode formed of the material, and to a non-aqueous electrolyte secondary battery including the electrode. More particularly, the present invention relates to a negative electrode material for producing a lithium secondary battery, to a negative electrode formed of the material, and to a lithium secondary battery including the electrode.

2. Description of the Related Art

In accordance with development of portable apparatuses having small size, light weight, and high performance, there is an increasing demand for a lithium ion secondary battery having high energy density; i.e., a lithium ion secondary battery of high capacity. Most lithium ion secondary batteries employ, as a negative electrode material, graphite fine powder, which can intercalate lithium ions between graphite layers. Since graphite of high crystallinity exhibits a high discharging capacity, attempts have been made to employ graphite material of high crystallinity (natural graphite has the highest crystallinity) as a negative electrode material for producing a lithium ion secondary battery. In recent years, a graphite material has been developed exhibiting a discharging capacity within a practical range of 350 to 360 mAh/g, which is nearly equal to the theoretical discharging capacity of graphite; i.e., 372 mAh/g.

However, use of graphite material of high crystallinity causes the following problems: an increase in irreversible capacity, and lowering of coulomb efficiency (i.e., discharging capacity/charging capacity at the first charging/discharging cycle), which are considered to be caused by decomposition of an electrolytic solution (see J. Electrochem. Soc., Vol. 117, 1970, page 222). In order to solve such problems, a negative electrode material has been proposed containing a carbon material of high crystallinity whose surface is coated with amorphous carbon. Such electrode material suppresses a lowering of coulomb efficiency and an increase in irreversible capacity, which are considered to be caused by decomposition of an electrolytic solution, as well as deterioration of cycle characteristics (see Japanese Patent No. 2643035 or Japanese Patent No. 2976299). However, the technique disclosed in JPN 2643055, in which an amorphous carbon layer is formed on the surface of a carbon material of high crystallinity by means of CVD (chemical vapor deposition), involves considerable practical problems of production cost and mass productivity. JPN 2976299 and other documents disclose a technique employing liquid-phase carbonization, which is advantageous from the viewpoints of production cost and mass productivity. However, when a negative electrode material is formed merely by mixing an organic compound in liquid form with graphite fine particles and firing the resultant mixture, the graphite fine particles are melt-bonded and aggregated with one another during the course of carbonization, and therefore the thus-aggregated particles must be pulverized. When the aggregated graphite particles are pulverized, the surface of a carbon material of high crystallinity is newly exposed, leading to a lowering of coulomb efficiency and deterioration of cycle characteristics.

### SUMMARY OF THE INVENTION

It is therefore an object of the present invention to provide a negative electrode material for producing a lithium ion secondary battery having a high discharging capacity and low irreversible capacity, and exhibiting excellent coulomb efficiency and excellent cycle characteristics, the negative electrode material being obtained by forming a carbonaceous layer on the surface of a carbon material through a relatively simple process.

In order to solve the aforementioned problems of the prior art, the present inventors have performed extensive studies. As a result, the present inventors have found that when a crystalline carbon layer containing amorphous carbon regions is formed on the surface of carbonaceous powder serving as a nucleus (the powder having high-crystalline carbon regions and amorphous carbon regions, which are observed in a bright-field image obtained by use of a transmission electron microscope), a negative electrode material for a lithium ion secondary battery is obtained having high discharging capacity and low irreversible capacity and exhibiting excellent coulomb efficiency and excellent cycle characteristics. The present invention has been accomplished on the basis of this finding.

Accordingly, the present invention provides the following.

1. A negative electrode material comprising carbonaceous powder serving as a nucleus, and a carbon layer formed on the surface of the powder, characterized in that the carbon layer, when observed under a transmission electron microscope, has crystalline carbon regions and amorphous carbon regions in a bright-field image thereof, and the ratio of the intensity of a peak at 1,360 cm⁻¹ in a laser Raman spectrum of the carbon layer to that of a peak at 1,580 cm⁻¹ in the spectrum is 0.3 or less.

2. The negative electrode material according to 1 above, wherein the carbonaceous powder has crystalline carbon regions and amorphous carbon regions, and the ratio by area of crystalline carbon regions of the carbonaceous powder serving as a nucleus to amorphous carbon regions of the powder is 95 to 50:5 to 50 as calculated from a bright-field image of the powder obtained by use of a transmission electron microscope.

3. The negative electrode material according to 1 above, wherein the ratio by area of the crystalline carbon regions of the carbon layer to the amorphous carbon regions of the layer is 99 to 60:1 to 40 as calculated from a bright-field image of the carbon layer obtained by use of a transmission electron microscope.

4. The negative electrode material according to 1 above, wherein the size Lc1 of crystallites constituting the carbon layer as measured along the c-axis of the layer, and the size Lc2 of crystallites constituting the carbonaceous powder as measured along the c-axis of the powder, satisfy the relation represented by the following formula (1):

Lc1<Lc2 (1).

5. The negative electrode material according to 1 above, wherein the size La2 of crystallites constituting the carbon layer as measured along the a-axis of the layer, and the size La2 of crystallites constituting the carbonaceous powder as measured along the a-axis of the powder, satisfy the relation represented by the following formula (2):

La1<La2 (2).

6. The negative electrode material according to any one of 1 through 5 above, wherein, in a bright-field image of the carbon layer obtained by use of a transmission electron microscope, the amorphous carbon regions are randomly dispersed in the crystalline carbon regions.

7. The negative electrode material according to 1 above, wherein the carbon layer is formed by depositing a composition containing a phenolic resin, and a drying oil or a fatty acid derived therefrom onto carbonaceous powder serving as a nucleus in the presence of water, and thermally treating the composition-deposited powder in a non-oxidative atmosphere at a temperature of at least 2,500° C.

8. The negative electrode material according to 1 above, wherein the carbon layer is formed by depositing a composition containing a phenolic resin, and a drying oil or a fatty acid derived therefrom onto carbonaceous powder serving as a nucleus in the presence of water, and thermally treating a mixture of the composition-deposited powder and vapor grown carbon fiber in a non-oxidative atmosphere at a temperature of at least 2,500° C.

9. The negative electrode material according any one of 1 through 8 above, wherein the average roundness of particles of the carbonaceous powder serving as a nucleus is 0.85 to 0.99 as measured by use of a flow particle image analyzer.

10. The negative electrode material according to 9 above, wherein the carbonaceous powder particles contain particles having a roundness of less than 0.90 as measured by use of a flow particle image analyzer in an amount of 2 to 20% by number of particles.

11. The negative electrode material according to 8 above, wherein the amount of the vapor grown carbon fiber is 0.01 to 20 mass % of the mixture.

12. The negative electrode material according to 8 above, wherein a fiber filament of the vapor grown carbon fiber includes a hollow space extending along its center axis, and has an outer diameter of 2 to 1,000 nm and an aspect ratio of 10 to 15,000.

13. The negative electrode material according to 11 or 12 above, wherein the vapor grown carbon fiber is a branched carbon fiber.

14. The negative electrode material according to any one of 11 through 13 above, wherein the vapor grown carbon fiber contains carbon having, at a (002) plane, an average interlayer distance (d₀₀₂) of 0.344 nm or less as measured by means of X-ray diffractometry.

15. The negative electrode material according to any one of 1 through 14 above, wherein a carbon layer of high crystallinity on the surface of the carbonaceous powder serving as a nucleus is obtained by firing a composition, deposited on said carbonaceous powder, containing a polymer selected from the group consisting of a phenolic resin, a polyvinyl alcohol resin, a furan resin, a cellulose resin, a polystyrene resin, a polyimide resin, and an epoxy resin.

16. A method for producing a negative electrode material which comprises depositing a composition containing a polymer onto at least a portion of the surface of carbonaceous powder serving as a nucleus in the presence of water; mixing the resultant carbonaceous powder with vapor grown carbon fiber; and subsequently thermally treating, in a non-oxidative atmosphere, the carbonaceous powder onto which the polymer-containing composition has been deposited.

17. The method for producing a negative electrode material according to 16 above, wherein the thermal treatment step comprises firing at a temperature of at least 2,500° C.

18. An electrode paste comprising a negative electrode material as recited in any one of 1 through 15 above, and a binder.

19. An electrode comprising a molded product of an electrode paste as recited in 18 above.

20. A secondary battery comprising an electrode as recited in 19 above.

21. A secondary battery according to 20 above, which comprises a non-aqueous electrolytic solvent and an electrolyte, wherein the non-aqueous electrolytic solvent is at least one species selected from the group consisting of ethylene carbonate, diethyl carbonate, dimethyl carbonate, methyl ethyl carbonate, and propylene carbonate.

### BRIEF DESCRIPTION OF THE DRAWINGS

FIG. 1 shows a transmission electron micrograph (×25,000) of the negative electrode material of Example 1.

FIG. 2 shows a transmission electron micrograph (×25,000) of the negative electrode material of Comparative Example 2.

### DETAILED DESCRIPTION OF THE INVENTION

The present invention will next be described in detail.

Carbonaceous Powder

Carbonaceous powder employed in the present invention, which serves as a matrix (nucleus) and enables lithium ions to be intercalated thereinto, has crystalline carbon regions and amorphous carbon regions, which are observed in a bright-field image of the powder obtained by use of a transmission electron microscope. Conventionally, a transmission electron microscopy technique has been employed for analysis of the structure of a carbon material. Particularly when a high-resolution microscopy technique which can show a lattice image corresponding to a carbon crystal plane (in particular, a 002 lattice image corresponding to a hexagonal network plane) is employed, the layered structure of a carbon material can be directly observed at a magnification of about 400,000 or more. The crystalline carbon regions and amorphous carbon regions of the carbonaceous powder can be analyzed by means of transmission electron microscopy, which is an effective technique for characterization of carbon.

Specifically, a region to be investigated of the bright-field image of the carbonaceous powder is subjected to selected area diffraction (SAD) analysis, and investigation is performed on the basis of the resultant diffraction patterns. SAD analysis is described in detail in “Saishin no Tanso Zairyo Jikken Gijuitsu (Bunseki Kaiseki Hen),” edited by The Carbon Society of Japan (SIPEC Corporation), pp. 18-26 and 44-50, and Michio Inagaki, et al., “Kaitei Tanso Zairyo Nyumon,” edited by The Carbon Society of Japan, pp. 29-40.

As used herein, the term “crystalline carbon region” refers to a region exhibiting a characteristic feature as observed in a diffraction pattern of a product obtained through, for example, treatment of graphitizable carbon at 2,800° C., and the term “amorphous carbon region” refers to a region exhibiting a characteristic feature as observed in a diffraction pattern of a product obtained through, for example, treatment of non-graphitizable carbon at 1,200 to 2,800° C. A “crystalline carbon region” exhibits two or more spot diffraction patterns in a selected area diffraction pattern. Examples of the graphitizable carbon forming a crystalline carbon region upon heat treatment at 2,800° C. include petroleum coke, pitch coke, caking coal coke and polyvinyl chloride coke. An “amorphous carbon region” exhibits a diffraction pattern in which only one spot derived from the (002) plane is observed in the selected area diffraction pattern. Examples of the non-graphitizable carbon forming an amorphous carbon region upon heat treatment 1,200 to 2,800° C. include carbon black, cellulose carbon, phenolformaldehyde resin coke and polyvinylidene chloride coke.

In the carbonaceous powder serving as a nucleus, preferably, the ratio by area of the crystalline carbon regions to the amorphous carbon regions is 95 to 50:5 to 50 as calculated from a bright-field image of the powder obtained by use of a transmission electron microscope. More preferably, the area ratio is 90 to 50:10 to 50. When the area ratio of the crystalline carbon regions of the carbonaceous powder to the amorphous carbon regions thereof is lower than 50:50, the resultant negative electrode material fails to exhibit high discharging capacity. In contrast, when the area ratio of the crystalline carbon regions to the amorphous carbon regions is higher than 95:5; i.e., the carbonaceous powder contains large amounts of the crystalline carbon regions, unless the surface of the powder is completely coated with a carbon layer, coulomb efficiency is lowered and cycle characteristics are deteriorated.

Particles of the carbonaceous powder serving as a nucleus may assume, for example, a lump-like shape, a flaky shape, a spherical shape, or a fibrous shape. Preferably, the particles assume a spherical shape or a lump-like shape.

The carbonaceous powder particles preferably have an average roundness of 0.85 to 0.99 as measured by use of a flow particle image analyzer. When the average roundness is lower than 0.85, the packing density of the particles fails to increase during the course of forming an electrode, leading to lowering of discharging capacity per unit volume. In contrast, when the average roundness is higher than 0.99, the carbonaceous powder particles contain virtually no fine particles, which have a low roundness, and thus discharging capacity fails to increase during the course of forming an electrode. Preferably, the amount of particles having a roundness of less than 0.90 contained in the carbonaceous powder particles is regulated to 2 to 20% by number of particles. The average roundness can be regulated by use of a particle shape control apparatus employing, for example, mechanofusion treatment.

The central particle size (D50) of particles of the carbonaceous powder serving as a matrix (nucleus), which is obtained from the volume-based particle size distribution measured by use of a flow particle image analyzer, is preferably about 1 to about 80 μm, more preferably 5 to 40 μm, much more preferably 10 to 30 μm. Preferably, the carbonaceous powder particles contain substantially no particles having a particle size falling within a range of 1 μm or less and/or 80 μm or more. The particle size is regulated so as to fall within the above preferred range, for the following reasons. When the particle size of the carbonaceous powder particles is large, the particles are micronized through charging/discharging reaction, leading to deterioration of cycle characteristics. In contrast, when the particle size of the carbonaceous powder particles is small, the particles fail to efficiently participate in electrochemical reaction with lithium ions, leading to lowering of capacity and deterioration of cycle characteristics.

In order to regulate the particle size, any known technique such as pulverization or classification may be employed. Specific examples of the apparatus employed for pulverization include a hammer mill, a jaw crusher, and an impact mill. The classification may be air classification or classification employing a sieve. Examples of the apparatus employed for air classification include a turbo classifier and a turbo plex.

Surface Carbon Layer

A carbon layer covering the surface of the matrix (nucleus) is preferably formed of a dense carbonaceous material obtained by firing a phenolic resin mixed with a drying oil or a fatty acid derived therefrom. A drying-oil-modified phenolic resin obtained by chemical reaction between the phenolic resin and unsaturated bonds of the drying oil is considered to mitigate decomposition and to prevent effervescence during the course of thermal treatment (or firing). The drying oil has, in addition to carbon-carbon double bonds, considerably long alkyl groups and ester bonds, and the alkyl groups and ester bonds are considered to facilitate, for example, effective removal of gas during the course of firing.

A phenolic resin is produced by reaction between a phenol compound and an aldehyde. Examples of the phenolic resin which may be employed include non-modified phenolic resins such as novolak and resol; and partially modified phenolic resins. If desired, the phenolic resin may contain rubber such as nitrile rubber. Examples of the phenol compound serving as a raw material include phenol, cresol, xylenol, and alkylphenols having an alkyl group having 20 carbon atoms or less.

In the present invention, the phenolic resin containing a drying oil or a fatty acid derived therefrom may be prepared by the following method: a method in which firstly a phenol and a drying oil are subjected to addition reaction in the presence of a strong acid catalyst, and subsequently a basic catalyst is added to the resultant reaction mixture such that the mixture exhibits basicity, followed by formalin addition reaction; or a method in which a phenol is reacted with formalin, and then a drying oil is added to the resultant reaction mixture.

When the drying oil (e.g., vegetable oil) is spread so as to form a thin film and then allowed to stand in air, the drying oil is dried and solidified within a relatively short period of time. Examples of the drying oil include generally known oils such as tung oil, linseed oil, dehydrated castor oil, soybean oil, and cashew nut oil. Fatty acids derived from these drying oils may also be employed.

The amount of the drying oil or a fatty acid derived therefrom is preferably 5 to 50 parts by mass on the basis of 100 parts by mass of the phenolic resin (e.g., a product obtained through condensation of phenol and formalin). When the amount of the drying oil or a fatty acid derived therefrom exceeds 50 parts by mass, the resultant carbon layer exhibits lowered adhesion to the carbonaceous powder serving as a nucleus and fibrous carbon.

Preferably, the polymer is diluted with a solvent such as water, acetone, ethanol, or toluene to thereby regulate its viscosity, and the resultant solution is deposited onto the carbonaceous powder in the presence of water.

Deposition of the polymer is carried out under atmospheric pressure, increased pressure, or reduced pressure. Preferably, deposition is carried out under reduced pressure, since affinity between the carbonaceous powder and the polymer is enhanced.

In the present invention, preferably, the polymer employed for forming the surface carbon layer exhibits adhesion to the carbonaceous powder serving as a nucleus and fibrous carbon. When a polymer exhibiting adhesiveness is present between the carbonaceous powder and the fibrous carbon, so as to bring these materials into contact with each other, these materials are united through chemical bonding by means of, for example, covalent bonds, van der Waals forces, or hydrogen bonds, or through physical adsorption by means of, for example, an anchoring effect. Any polymer may be employed in the present invention, so long as the polymer, when undergoing treatment such as mixing, stirring, removal of solvent, or thermal treatment, exhibits resistance against, for example, compression, bending, exfoliation, impact, tension, or tearing such that the polymer causes substantially no exfoliation of the carbon layer. Preferably, the polymer is selected from the group consisting of a phenolic resin, a polyvinyl alcohol resin, a furan resin, a cellulose resin, a polystyrene resin, a polyimide resin, and an epoxy resin. A phenolic resin and a polyvinyl alcohol resin are more preferred.

In the present invention, the surface carbon layer exhibits high crystallinity, and the ratio of the intensity of a peak at 1,360 cm⁻¹ in a laser Raman spectrum of the carbon layer to that of a peak at 1,580 cm⁻¹ in the spectrum is 0.3 or less. When the peak intensity ratio is more than 0.3, the surface carbon layer exhibits insufficient crystallinity, and discharging capacity of the thus-coated carbon material and coulomb efficiency are lowered.

In the present invention, the thickness of the surface carbon coating layer is 1 to 30,000 nm, preferably 1,000 to 10,000 nm. When the thickness of the coating layer is less than 1 nm, the carbonaceous powder serving as a nucleus fails to be uniformly coated with the layer, leading to lowering of coulomb efficiency and deterioration of cycle characteristics. In contrast, when the thickness of the coating layer exceeds 30,000 nm, since the preferred particle size of the carbonaceous powder is 0.1 to 80 μm, the particle size of the layer-coated carbonaceous powder may become greater than the thickness of a negative electrode for producing a lithium ion secondary battery, which must fall within a range of 70 to 100 μm.

The size of individual crystallites constituting a graphite crystal as measured along the a-axis of the crystal; i.e., La, and the thickness of the crystallite as measured along the c-axis of the crystal; i.e., Lc, can be measured by means of a known technique, such as powder X-ray diffractometry (XRD) (see Inakichi Noda and Michio Inagaki, Japan Society for the Promotion of Science, 117th committee document, 117-71-A-1 (1963); Michio Inagaki, et al., Japan Society for the Promotion of Science, 117th committee document, 117-121-C-5 (1972); and Michio Inagaki, “Tanso,” 1963, No. 36, pp. 25-34).

However, in the case of the present invention, in which the surface of the carbonaceous powder is coated with the carbon layer having a thickness of about several nm to about several μm, the crystallite parameter of the local structure of the layer-coated powder may be difficult to determine by means of the aforementioned technique. In such a case, the parameter may be calculated from an image of the powder obtained by means of transmission electron microscopy (TEM). As known to those skilled in the art, the parameter calculated by means of XRD becomes nearly equal to that calculated by means of TEM (see Michio Inagaki, et al., “Kaitei Tanso Zairyo Nyumon,” edited by The Carbon Society of Japan, page 33).

In general, La and Lc of difficult-to-graphitize carbon which has undergone graphitization are 70 to 80 Å or less and 30 to 40 Å or less, respectively. A characteristic feature of the carbon material of the present invention resides in that the material is formed of a non-uniform structure in which relatively high crystalline carbon regions and amorphous carbon regions are localized. Preferably, the structure of high crystallinity has La and Lc greater than those of general graphitized non-graphitizable carbon. Specifically, La is 100 Å or more, and Lc is 50 Å or more.

In the present invention, preferably, Lc1 of the surface carbon layer and Lc2 of the carbonaceous powder serving as a nucleus satisfy the relation represented by the following formula (1):

Lc1<Lc2 (1);

and La1 of the surface carbon layer and La2 of the carbonaceous powder satisfy the relation represented by the following formula (2): La1<La2 (2).

In the case where Lc1≧Lc2 or La1≧La2, discharging capacity is lowered. Preferably, at least 50% by number of crystallites constituting the surface carbon layer satisfy formulae (1) and (2) above relative to all of the crystallites constituting the carbonaceous powder.

Mixing Method

In the present invention, the carbonaceous powder serving as a nucleus onto which the polymer has been deposited is mixed with particles containing a mixture containing vapor grown carbon fiber, and the resultant mixture is subjected to stirring, to thereby disperse the vapor grown carbon fiber in the mixture. No particular limitations are imposed on the stirring method, and a stirring apparatus such as a ribbon mixer, a screw kneader, a Spartan ryuzer, a Lodige mixer, a planetary mixer, or a general-purpose mixer may be employed.

In the case where the particles are coated with a carbonaceous material, the stirring temperature and stirring time are appropriately calculated in accordance with, for example, the components and viscosity of the particles and the polymer. The stirring temperature is generally about 0° C. to about 50° C., preferably about 10° C. to about 30° C.

Alternatively, in order to reduce the viscosity of the aforementioned mixture to 500 Pa·s or less at the mixing temperature, the mixing time is regulated, and the composition is diluted with a solvent. In this case, any solvent may be employed without particular limitation, so long as the solvent exhibits good affinity with the polymer and the fibrous carbon. Examples of the solvent include water, alcohols, ketones, aromatic hydrocarbons, and esters. Preferred examples include water, methanol, ethanol, butanol, acetone, methyl ethyl ketone, toluene, ethyl acetate, and butyl acetate.

After completion of stirring, preferably, a portion or the entirety of the solvent is removed. Removal of the solvent may be carried out by means of a known technique such as hot air drying or vacuum drying.

The drying temperature varies with, for example, the boiling point and vapor pressure of the employed solvent. Specifically, the drying temperature is 50° C. or higher, preferably 100° C. to 1,000° C. inclusive, more preferably 150° C. to 500° C. inclusive.

Any type of known heating apparatuses may be employed without particular limitation for heating and curing. However, from the viewpoint of productivity, for example, a rotary kiln or a belt-type continuous furnace, which enables continuous treatment, is preferably employed in a production process.

The amount of the phenolic resin to be added is preferably 2 mass % to 30 mass %, more preferably 4 mass % to 25 mass %, much more preferably 6 mass % to 18 mass %.

Thermal Treatment Conditions

In order to increase charging/discharging capacity due to intercalation of, for example, lithium ions, the crystallinity of the carbon material must be enhanced. Since the crystallinity of carbon is generally enhanced in accordance with the highest temperature in thermal hysteresis, in order to enhance battery performance, thermal treatment is preferably carried out at a higher temperature. The thermal treatment temperature is preferably 2,500° C. or higher, more preferably 2,800° C. or higher, much more preferably 3,000° C. or higher.

In the case where the carbonaceous powder serving as a nucleus is formed of a matrix of high carbon crystallinity, such as natural graphite or artificial graphite which has undergone thermal treatment, the center of the matrix is not necessarily heated to the maximum temperature. However, even in such a case, in order to enhance crystallinity of the surface carbon layer, thermal treatment must be carried out to some extent. The thermal treatment temperature is preferably 2,500° C. or higher, more preferably 2,800° C. or higher, much more preferably 3,000° C. or higher. When the thermal treatment temperature is lower than 2,500° C., crystallinity of the surface carbon layer is insufficiently enhanced, and thus discharging capacity and coulomb efficiency are lowered.

In the case where the carbonaceous powder is subjected to thermal treatment by use of a known heating apparatus, when the temperature increasing rate falls within a range of the maximum temperature increasing rate and the minimum temperature increasing rate in the apparatus, the performance of the powder is not considerably affected. However, since the powder raises few problems such as cracking (such a problem occurs in, for example, a molded material), from the viewpoint of production cost, the temperature increasing rate is preferably high. The time elapsed when the powder is heated from ambient temperature to the maximum temperature is preferably 12 hours or less, more preferably six hours or less, particularly preferably two hours or less.

Any known thermal treatment apparatus, such as an Acheson furnace or a direct electrical heating furnace, may be employed for firing. Such an apparatus is advantageous from the viewpoint of production cost. However, preferably, a furnace having a structure such that the interior of the furnace can be filled with an inert gas such as argon or helium is employed, since the resistance of the powder may be lowered in the presence of nitrogen gas, and the strength of the carbonaceous material may be lowered through oxidation by oxygen. Preferred examples of such a furnace include a batch furnace whose interior enables evacuation and gas substitution, a batch furnace in which the interior atmosphere can be controlled by means of a tubular furnace, and a continuous furnace.

Vapor Grown Carbon Fiber

Vapor grown carbon fiber to be employed in the present invention must exhibit excellent electrical conductivity, and therefore, vapor grown carbon fiber having high crystallinity is preferably employed. When a negative electrode is formed from the carbon material, and the resultant electrode is incorporated into a lithium ion secondary battery, instantaneous current flow throughout the negative electrode is required. Therefore, preferably, the crystal growth direction of vapor grown carbon fiber to be employed is parallel to the axis of each fiber filament of the fiber, and the fiber filament has branches. When the vapor grown carbon fiber is branched carbon fiber, electrical connection is readily established between the carbon particles by means of the carbon fiber, whereby electrical conductivity is enhanced.

In order to attain the object of the present invention, preferably, vapor grown carbon fiber is employed containing carbon crystals grown along the axis of each fiber filament of the fiber, in which the fiber filament has branches. Vapor grown carbon fiber can be produced through, for example, the following procedure: a gasified organic compound is fed into a high-temperature atmosphere together with iron serving as a catalyst.

The vapor grown carbon fiber to be employed may be as-produced carbon fiber; carbon fiber which has undergone thermal treatment at, for example, 800 to 1,500° C.; or carbon fiber which has undergone graphitization at, for example, 2,000 to 3,000° C. However, as-produced carbon fiber or carbon fiber which has undergone thermal treatment at about 1,500° C. is more preferred.

The vapor grown carbon fiber employed in the present invention is preferably branched carbon fiber. The individual fiber filaments of the branched carbon fiber may have a hollow structure in which a hollow space extends throughout the filament, including a branched portion thereof. Therefore, sheath-forming carbon layers of the filament assume uninterrupted layers. As used herein, the term “hollow structure” refers to a structure in which a plurality of carbon layers form a sheath. The hollow cylindrical structure encompasses a structure in which sheath-forming carbon layers form an incomplete sheath; a structure in which the carbon layers are partially broken; and a structure in which the laminated two carbon layers are formed into a single carbon layer. The cross section of the sheath does not necessarily assume a round shape, and may assume an elliptical shape or a polygonal shape. No particular limitations are imposed on the interlayer distance (d₀₀₂) of carbon crystal layers. The interlayer distance (d₀₀₂) of the carbon crystal layers as measured by means of X-ray diffractometry is preferably 0.344 nm or less, more preferably 0.339 nm or less, much more preferably 0.338 nm or less. The thickness (Lc) of the carbon crystal layer in the C axis direction is 40 nm or less.

The outer diameter of the individual fiber filaments of the vapor grown carbon fiber employed in the present invention is 2 to 1,000 nm, and the aspect ratio of the filament is 10 to 15,000. Preferably, at least 50% by number of fiber filaments of the vapor grown carbon fiber have an outer diameter of 2 to 1,000 nm and an aspect ratio of 10 to 15,000. Preferably, the fiber filament has an outer diameter of 10 to 500 nm and a length of 1 to 100 μm (i.e., an aspect ratio of 2 to 2,000); or an outer diameter of 2 to 50 nm and a length of 0.5 to 50 μm (i.e., an aspect ratio of 10 to 25,000).

When the vapor grown carbon fiber is subjected to thermal treatment at 2,000° C. or higher after the carbon fiber has been produced, crystallinity of the carbon fiber is further enhanced, thereby increasing electrical conductivity. In such a case, an effective measure is addition of boron, which facilitates graphitization, to the carbon fiber before thermal treatment.

The amount of the vapor grown carbon fiber contained in the negative electrode material is preferably 0.01 to 20 mass %, more preferably 0.1 to 15 mass %, much more preferably 0.5 to 10 mass %. When the amount of the carbon fiber exceeds 20 mass %, electrical capacity is lowered, whereas when the amount of the carbon fiber is less than 0.01 mass %, internal electrical resistance at a low temperature (e.g., −35° C.) increases.

The vapor grown carbon fiber has, on its surface, large amounts of irregularities and rough portions. Therefore, the vapor grown carbon fiber exhibits enhanced adhesion to particles of the carbonaceous powder serving as a nucleus, and thus, even in the case where charging/discharging cycles are repeated, the carbon fiber, which also serves as a negative electrode active substance and an electrical conductivity imparting agent, adheres to the powder and is not dissociated therefrom, whereby electronic conductivity is maintained and cycle characteristics are enhanced.

When the vapor grown carbon fiber contains a large amount of branched carbon fiber, a network can be formed in an efficient manner, and thus high electric conductivity and thermal conductivity are readily obtained. In addition, when the vapor grown carbon fiber contains a large amount of branched carbon fiber, the carbon fiber can be dispersed in the active substance so as to wrap the substance, and thus the strength of the negative electrode material is enhanced, and good contact is established between the particles.

When the vapor grown carbon fiber is inserted between the particles, the negative electrode material exhibits an enhanced effect of holding an electrolytic solution, and doping or dedoping of lithium ions is smoothly carried out even under low temperature conditions.

Coated Carbon Material

In the present invention, the carbonaceous powder particles coated with the carbon layer of high crystallinity preferably have an average roundness of 0.85 to 0.99 as measured by use of a flow particle image analyzer (the measurement method is described below in the Examples). When the average roundness is smaller than 0.85, the packing density of the particles fails to increase during the course of formation of an electrode, leading to lowering of discharging capacity per unit volume. In contrast, when the average roundness is greater than 0.99, the carbonaceous powder particles contain virtually no fine particles, which have a low roundness, and thus discharging capacity fails to increase during the course of formation of an electrode. Preferably, the amount of particles having a roundness of less than 0.90 contained in the carbonaceous powder particles is regulated to 2 to 20% by number of particles.

The central particle size (D50) of the carbonaceous powder particles coated with the carbon layer of high crystallinity, the particle size being obtained from the volume-based particle size distribution measured by use of a flow particle image analyzer, is preferably about 1 to about 80 μm, more preferably 5 to 40 μm, much more preferably 10 to 30 μm.

When the average particle size is less than 1 μm, the aspect ratio tends to become high, and the specific surface area tends to become large. For example, in the case of production of a battery electrode, in general, the negative electrode material is mixed with a binder to prepare a paste, and the resultant paste is applied to a collector. When the average particle size of the particles constituting the negative electrode material is less than 1 μm, the electrode material contains large amounts of fine particles having a size less than 1 μm. Therefore, the viscosity of the paste is increased, and applicability of the paste is lowered.

When the negative electrode material contains large particles having an average particle size of 80 μm or more, large amounts of irregularities are formed on the surface of the resultant electrode, thereby causing generation of scratches on a separator to be employed in a battery. When the negative electrode material contains substantially neither particles having a particle size of 1 μm or less nor particles having a particle size of 80 μm or more, the negative electrode material is preferably employed for forming an electrode.

Production of Secondary Battery

Any known method can be employed for producing a lithium secondary battery from the negative electrode material of the present invention. The techniques and structures described in U.S. Pat. No. 5,478,364 and U.S. Pat. No. 5,965,296, incorporated herein by reference, can be employed for producing a lithium secondary battery from the negative electrode material of the present invention.

In the case where a lithium battery electrode is formed from the negative electrode material, preferably, the negative electrode material has a small specific surface area. The negative electrode material of the present invention has a specific surface area of 3 m²/g or less as measured by means of the BET method. When the specific surface area exceeds 3 m²/g, surface activity of the particles constituting the negative electrode material is increased, and coulomb efficiency is lowered as a result of, for example, decomposition of an electrolytic solution. In order to increase capacity of a battery, the packing density of the particles must be increased. In order to increase the packing density, each of the particles preferably assumes a virtually spherical shape. When the shape of the individual particles is represented by an aspect ratio (i.e., the length of the major axis/the length of the minor axis), the aspect ratio is 6 or less, preferably 5 or less. The aspect ratio may be obtained by use of, for example, a micrograph of the particles. Alternatively, the aspect ratio may be calculated through the following procedure: the average particle size (A) of the particles is measured by means of the laser diffraction-scattering method; the average particle size (B) of the particles is measured by means of an electrical detection method (a Coulter counter method); each of the particles is regarded as a disk, with the bottom surface diameter of the disk being represented by (A); the volume (C) of the disk is calculated from the formula: C=4/3×(B/2)³π; the thickness (T) of the disk is calculated from the formula: T=C/(A/2)²π; and the aspect ratio is calculated as A/T.

In the case where a lithium battery electrode is formed from the negative electrode material, when the material exhibits good fillability and has high bulk density, the resultant electrode exhibits high discharging capacity per unit volume.

A lithium battery electrode can be produced through the following procedure: a binder is diluted with a solvent and then kneaded with the negative electrode material in a general manner, and the resultant mixture is applied to a collector (substrate).

Examples of the binder which may be employed include known binders, such as fluorine-containing polymers (e.g., polyvinylidene fluoride and polytetrafluoroethylene), and rubbers (e.g., SBR (styrene-butadiene rubber)). Any known solvent suitable for a binder to be used may be employed without particular limitation. When a fluorine-containing polymer is employed as a binder, for example, toluene or N-methylpyrrolidone is employed as a solvent. When SBR is employed as a binder, for example, water is employed as a solvent.

The amount of the binder to be employed is preferably 1 to 30 parts by mass, particularly preferably about 3 to about 20 parts by mass, on the basis of 100 parts by mass of the negative electrode material.

Kneading of the negative electrode material with the binder may be carried out by use of any known apparatus such as a ribbon mixer, a screw kneader, a Spartan ryuzer, a Lodige mixer, a planetary mixer, or a general-purpose mixer.

The thus-kneaded mixture may be applied to a collector by means of a known method without particular limitation. For example, the mixture is applied to the collector by use of a doctor blade, a bar coater, or a similar apparatus, and then the resultant collector is subjected to molding through, for example, roll pressing.

Examples of the collector which may be employed include known materials such as copper, aluminum, stainless steel, nickel, and alloys thereof.

Any known separator may be employed, but polyethylene- or polypropylene-made nonwoven fabric is particularly preferred.

In the lithium secondary battery of the present invention, the electrolytic solution may be a known organic electrolytic solution, and the electrolyte may be a known inorganic solid electrolyte or polymer solid electrolyte. From the viewpoint of electrical conductivity, an organic electrolytic solution is preferred.

Preferred examples of the organic solvent employed for preparing the organic electrolytic solution include ethers such as diethyl ether, dibutyl ether, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol dimethyl ether, and ethylene glycol phenyl ether; amides such as formamide, N-methylformamide, N,N-dimethylformamide, N-ethylformamide, N,N-diethylformamide, N-methylacetamide, N,N-dimethylacetamide, N-ethylacetamide, N,N-diethylacetamide, N,N-dimethylpropionamide, and hexamethylphosphoryl amide; sulfur-containing compounds such as dimethyl sulfoxide and sulfolane; dialkyl ketones such as methyl ethyl ketone and methyl isobutyl ketone; cyclic ethers such as ethylene oxide, propylene oxide, tetrahydrofuran, 2-methoxytetrahydrofuran, 1,2-dimethoxyethane, and 1,3-dioxolan; carbonates such as ethylene carbonate and propylene carbonate; γ-butyrolactone; N-methylpyrrolidone; acetonitrile; and nitromethane. More preferred examples include esters such as ethylene carbonate, butylene carbonate, diethyl carbonate, dimethyl carbonate, propylene carbonate, vinylene carbonate, and y-butyrolactone; ethers such as dioxolan, diethyl ether, and diethoxyethane; dimethyl sulfoxide; acetonitrile; and tetrahydrofuran. Particularly, carbonate-based non-aqueous solvents such as ethylene carbonate and propylene carbonate are preferably employed. These solvents may be employed singly or in combination of two or more species.

A lithium salt is employed as a solute (electrolyte) which is dissolved in the aforementioned solvent. Examples of generally known lithium salts include LiClO₄, LiBF₄, LiPF₆, LiAlCl₄, LiSbF₆, LiSCN, LiCl, LiCF₃SO₃, LiCF₃CO₂, and LiN(CF₃SO₂)₂.

Examples of the polymer solid electrolyte include polyethylene oxide derivatives and polymers containing the derivatives, polypropylene oxide derivatives and polymers containing the derivatives, phosphoric acid ester polymers, and polycarbonate derivatives and polymers containing the derivatives.

In the lithium secondary battery containing the negative electrode material of the present invention, preferably, a lithium-containing transition metal oxide is employed as a positive electrode active substance. Preferably, the positive electrode active substance is an oxide predominantly containing lithium and at least one transition metal selected from among Ti, V, Cr, Mn, Fe, Co, Ni, Mo, and W, in which the ratio by mol between lithium and the transition metal is 0.3 to 2.2. More preferably, the positive electrode active substance is an oxide predominantly containing lithium and at least one transition metal selected from among V, Cr, Mn, Fe, Co, and Ni, in which the ratio by mol between lithium and the transition metal is 0.3 to 2.2. The positive electrode active substance may contain Al, Ga, In, Ge, Sn, Pb, Sb, Bi, Si, P, B, etc., in an amount of less than 30 mol % on the basis of the entirety of the transition metal serving as a primary component. Of the aforementioned positive electrode active substances, a preferred substance is at least one species selected from among materials having a spinel structure and being represented by the formula LiₓMO₂ (wherein M represents at least one element selected from among Co, Ni, Fe, and Mn, and x is 0 to 1.2) or the formula Li_{y}N₂O₄ (wherein N includes at least Mn, and y is 0 to 2).

Particularly preferably, the positive electrode active substance is at least one species selected from among materials containing Li_{y}MₐD₁₋ₐO₂ (wherein M represents at least one element selected from among Co, Ni, Fe, and Mn; D represents at least one element selected from among Co, Ni, Fe, Mn, Al, Zn, Cu, Mo, Ag, W, Ga, In, Sn, Pb, Sb, Sr, B, and P, with the proviso that the element corresponding to M being excluded; y is 0 to 1.2; and a is 0.5 to 1); or at least one species selected from among materials having a spinel structure and being represented by the formula Li_{z}(NbE_{1-b})₂O₄ (wherein N represents Mn; E represents at least one element selected from among Co, Ni, Fe, Mn, Al, Zn, Cu, Mo, Ag, W, Ga, In, Sn, Pb, Sb, Sr, B, and P; b is 1 to 0.2; and z is 0 to 2).

Specific examples of the positive electrode active substance include LiₓCoO₂, LiₓNiO₂, LiₓMnO₂, LiₓCoₐNi₁₋ₐO₂, LiₓCo_{b}V_{1-b}O_{z}, LiₓCo_{b}Fe_{1-b}O₂, LiₓMn₂O₄, LiₓMn_{c}CO_{2-c}O₄, LiₓMn_{c}Ni_{2-c}O₄, LiₓMn_{c}V_{2-c}O₄, and LiₓMn_{c}Fe_{2-c}O₄ (wherein x is 0.02 to 1.2, a is 0.1 to 0.9, b is 0.8 to 0.98, c is 1.6 to 1.96, and z is 2.01 to 2.3). Examples of most preferred lithium-containing transition metal oxides include LiₓCoO₂, LiₓNiO₂, LiₓMnO₂, LiₓCoₐNi₁₋ₐO₂, LiₓMn₂O₄, and LiₓCO_{b}V_{1-b}O_{z} (wherein x is 0.02 to 1.2, a is 0.1 to 0.9, b is 0.9 to 0.98, and z is 2.01 to 2.3). The value x is measured before initiation of charging/discharging, and is increased or decreased through charging/discharging.

No particular limitations are imposed on the average particle size of particles of the positive electrode active substance, but the average particle size is preferably 0.1 to 50 μm. Preferably, the volume of particles having a particle size of 0.5 to 30 μm is 95% or more on the basis of the entire volume of the positive electrode active substance particles. More preferably, the volume of particles having a particle size of 3 μm or less is 18% or less on the basis of the entire volume of the positive electrode active substance particles, and the volume of particles having a particle size of 15 μm to 25 μm inclusive is 18% or less on the basis of the entire volume of the positive electrode active substance particles. No particular limitations are imposed on the specific surface area of the positive electrode active substance, but the specific surface area as measured by means of the BET method is preferably 0.01 to 50 m²/g, particularly preferably 0.2 m²/g to 1 m²/g. When the positive electrode active substance (5 g) is dissolved in distilled water (100 ml), the pH of the supernatant of the resultant solution is preferably 7 to 12 inclusive.

### EXAMPLES

The present invention will next be described in more detail with reference to the following representative examples, which should not be construed as limiting the invention thereto.

Method for Preparing Phenolic Resin for Deposition

A phenolic resin (varnish) which had been partially modified with tung oil was employed as a deposition material. Tung oil (100 parts by mass), phenol (150 parts by mass), and nonylphenol (150 parts by mass) were mixed together, and the resultant mixture was maintained at 50° C. Sulfuric acid (0.5 parts by mass) was added to the mixture, and the resultant mixture was stirred, gradually heated, and maintained at 120° C. for one hour, to thereby allow addition reaction between the tung oil and the phenols to proceed. Subsequently, the temperature of the resultant reaction mixture was lowered to 60° C. or lower, and hexamethylenetetramine (6 parts by mass) and 37 mass % formalin (100 parts by mass) were added to the mixture. The resultant mixture was reacted at 90° C. for about two hours, and then the resultant reaction mixture was dehydrated under vacuum. Thereafter, the resultant mixture was diluted with methanol (100 parts by mass) and acetone (100 parts by mass), to thereby yield a varnish having a viscosity of 20 mPa·s (at 20° C.). Hereinafter, the varnish will be called “varnish A.”

Method for Measuring Average Roundness and Volume-Based Particle Size

The average roundness and volume-based particle size of the carbon material of the present invention were measured by use of a flow particle image analyzer FPIA-2100 (product of Sysmex Corporation) as described below.

A measurement sample was subjected to cleaning (removal of micro dust) by use of a 106-μm filter. The sample (0.1 g) was added to ion-exchanged water (20 ml), and an anionic/nonionic surfactant (0.1 to 0.5 mass %) was added to the resultant mixture, whereby the sample was uniformly dispersed in the mixture. Dispersion of the sample was carried out for five minutes by use of ultrasonic cleaner UT-105S (product of Sharp Manufacturing Systems Corporation), to thereby prepare a dispersion containing the sample.

The summary of measurement principle, etc., is described in, for example, “Funtai to Kogyo,” VOL. 32, No. 2, 2000, or Japanese Patent Application Laid-Open (kokai) No. 8-136439. Specifically, the particle size is measured as follows.

When the measurement sample dispersion passes through the flow path of a flat, transparent flow cell (thickness: about 200 μm), the dispersion is irradiated with a strobe light at intervals of 1/30 seconds, and photographed by a CCD camera. Still images of a constant-volume dispersion are captured at intervals of 1/30 seconds. Therefore, when a predetermined number of the thus-captured still images is subjected to image analysis, the number of particles per unit volume can be quantitatively determined by particle size, whereby the volume-based particle size can be obtained.

The roundness is calculated by use of the following formula.

Roundness=(the peripheral length of a circle as calculated on the basis of circle-equivalent diameter)/(the peripheral length of a projected image of a particle)

The term “circle-equivalent diameter” refers to the diameter of a circle having a peripheral length equal to the actual peripheral length of a particle that has been obtained from a photograph of the particle. The roundness of the particle is obtained by dividing the peripheral length of a circle as calculated from the circle-equivalent diameter by the actual peripheral length of the particle. For example, a particle having a true round shape has a roundness of 1, whereas a particle having a more complicated shape has a smaller roundness.

The average roundness of particles is the average of the roundnesses of the particles as obtained by means of the above-described method.

Battery Evaluation Method

(1) Preparation of Paste

KF Polymer L1320 (an N-methylpyrrolidone (NMP) solution product containing polyvinylidene fluoride (PVDF) (12 mass %), product of Kureha Chemical Industry Co., Ltd.) (0.1 parts by mass) was added to a negative electrode material (1 part by mass), and the resultant mixture was kneaded using a planetary mixer, to thereby prepare a neat agent.

(2) Formation of Electrode

NMP was added to the neat agent so as to regulate the viscosity of the agent. The resultant mixture was applied onto a copper foil of high purity by use of a doctor blade so as to attain a thickness of 250 μm. The resultant product was dried under vacuum at 120° C. for one hour, and then subjected to punching, to thereby form an electrode having a size of 18 mmφ. The thus-formed electrode was sandwiched between super-steel-made pressing plates, and then subjected to pressing such that a pressure of 1×10³ to 3×10³ kg/cm² was applied to the electrode. Thereafter, the resultant electrode was dried in a vacuum drying apparatus at 120° C. for 12 hours, and was employed for evaluation.

(3) Production of Battery

A three-electrode cell was produced as follows. The below-described procedure was carried out in an atmosphere of dried argon having a dew point of −80° C. or lower.

In a polypropylene-made cell (inner diameter: about 18 mm) having a screw cap, a separator (polypropylene-made microporous film (Celgard 2400)) was sandwiched between the carbon electrode with copper foil (positive electrode) which had been formed in (2) above, and a metallic lithium foil (negative electrode), to thereby form a laminate. Subsequently, a metallic lithium foil serving as a reference electrode was laminated in a manner similar to that described above. Thereafter, an electrolytic solution was added to the cell, and the resultant cell was employed for testing.

(4) Electrolytic Solution

(i) EC electrolytic solution: prepared by dissolving LiPF₆ (1 mol/liter), serving as an electrolyte, in a mixture of EC (ethylene carbonate) (8 parts by mass) and DEC (diethyl carbonate) (12 parts by mass).

(5) Charging/Discharging Cycle Test

Constant-current constant-voltage charging/discharging test was performed at a current density of 0.2 mA/cm² (corresponding to 0.1 C).

Constant-current (CC) charging (i.e., intercalation of lithium ions into carbon) was performed at 0.2 mA/cm² while the voltage was increased from rest potential to 0.002 V. Subsequently, constant-voltage (CV) charging was performed at 0.002 V, and charging was stopped when the current value decreased to 25.4 μA.

CC discharging (i.e., release of lithium ions from carbon) was performed at 0.2 mA/cm² (corresponding to 0.1 C), and was cut off at a voltage of 1.5 V.

### Example 1

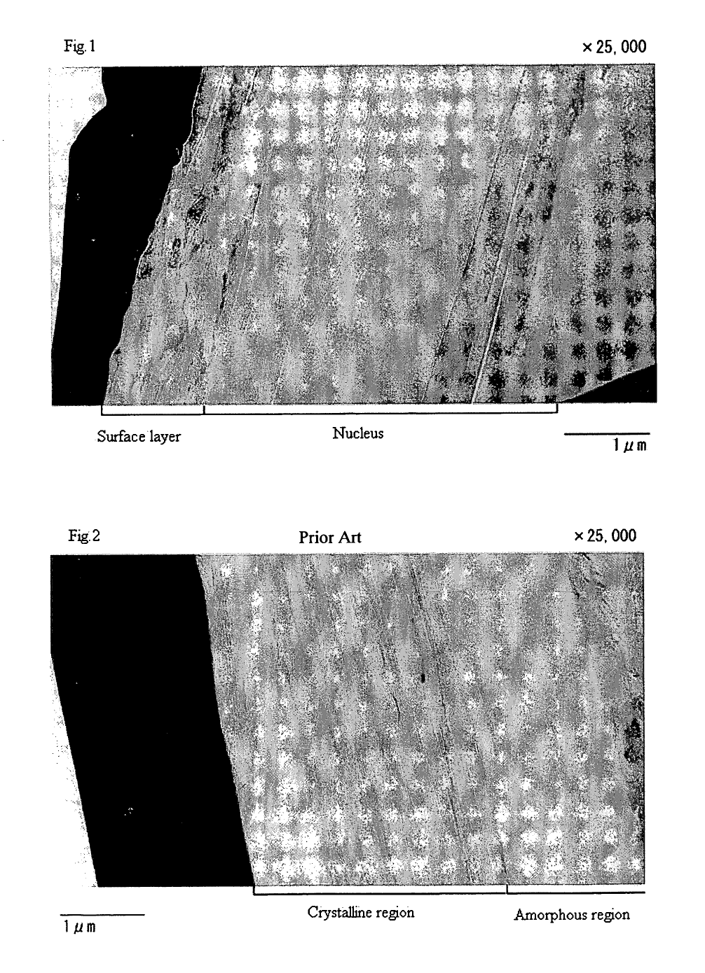

Carbonaceous powder was prepared, as a carbon material serving as a nucleus. In the carbonaceous powder, the particles of the powder had an average volume-based particle size (D50) of 20 μm and an average roundness of 0.88, in which the ratio by area of crystalline carbon regions of the powder to amorphous carbon regions thereof was 80:20 as calculated from a bright-field image of the powder obtained by use of a transmission electron microscope. Separately, water (5.0 parts by mass) was added to varnish A (5.5 parts by mass as reduced to resin solid content), and the resultant mixture was stirred, to thereby completely dissolve varnish A in the water. The resultant solution was added to the carbonaceous powder (100 g) such that the amount of the modified phenolic resin solid became 10 mass % based on the entirety of the carbonaceous powder, and the resultant mixture was kneaded for 30 minutes by use of a planetary mixer. The resultant mixture was dried in a vacuum drying apparatus at 80° C. for two hours. Subsequently, the thus-dried mixture was placed in a heating furnace, and the interior of the furnace was evacuated and then filled with argon. Subsequently, the furnace was heated under a stream of argon gas. The temperature of the furnace was maintained at 2,900° C. for 10 minutes, and then the furnace was cooled to room temperature. Thereafter, the thus-heat-treated product was screened using a sieve of 63-μm mesh, to thereby yield a negative electrode material sample having an undersize of 63 μm. FIG. 1 shows a transmission electron micrograph (×25,000) of the thus-obtained negative electrode material sample of Example 1. A laser Raman spectrum of the surface carbon layer of the sample was obtained. The ratio of the intensity of a peak at 1,360 cm⁻¹ in the spectrum to that of a peak at 1,580 cm⁻¹ in the spectrum; i.e., 1,360 cm⁻¹ peak intensity/1,580 cm⁻¹ peak intensity, was found to be 0.24.

The sample was subjected to battery evaluation by use of a single-cell-type battery evaluation apparatus employing the EC electrolytic solution.

In the charging/discharging cycle test, the capacity and coulomb efficiency at the 1st cycle and the capacity at the 50th cycle were measured. The results are shown in Table 1.

### Example 2

The procedure of Example 1 was repeated, except that vapor grown carbon fiber which had been graphitized at 2,800° C. (diameter of each fiber filament of the carbon fiber: 150 nm, aspect ratio of the fiber filament: 100) (1 mass %) was added to and stirred and mixed with the mixture obtained in Example 1, to thereby yield a sample. In a manner similar to Example 1, the above-obtained sample was subjected to battery evaluation by use of a single-cell-type battery evaluation apparatus employing the EC electrolytic solution. In the charging/discharging cycle test, the capacity and coulomb efficiency at the 1st cycle and the capacity at the 50th cycle were measured. The results are shown in Table 1.

### Example 3

The procedure of Example 2 was repeated, except that the amount of vapor grown carbon fiber to be added was changed to 10 mass %, to thereby yield a sample. In a manner similar to Example 2, the above-obtained sample was subjected to battery evaluation by use of a single-cell-type battery evaluation apparatus employing the EC electrolytic solution. In the charging/discharging cycle test, the capacity and coulomb efficiency at the 1st cycle and the capacity at the 50th cycle were measured. The results are shown in Table 1.

### Example 4

The procedure of Example 1 was repeated, except that there was employed, as a carbon material serving as a nucleus, carbonaceous powder, the particles of the powder having an average volume-based particle size (D50) of 25 μm and an average roundness of 0.93 to thereby yield a sample. Also the ratio by area of crystalline carbon regions of the powder to amorphous carbon regions thereof was 50:50 as calculated from a bright-field image of the powder obtained by use of a transmission electron microscope. In a manner similar to Example 1, the above-obtained sample was subjected to battery evaluation by use of a single-cell-type battery evaluation apparatus employing the EC electrolytic solution. In the charging/discharging cycle test, the capacity and coulomb efficiency at the 1st cycle and the capacity at the 50th cycle were measured. The results are shown in Table 1.

### Comparative Example 1

The procedure of Example 1 was repeated, except that there was employed, as a carbon material serving as a nucleus, graphitized mesocarbon microbeads (product of Osaka Gas Co., Ltd.) having an average volume-based particle size (D50) of 23 μm and an average roundness of 0.93, to thereby yield a sample. Also, the ratio by area of crystalline carbon regions of the microbeads to amorphous carbon regions thereof was 97:3 as calculated from a bright-field image of the microbeads obtained by use of a transmission electron microscope. In a manner similar to Example 1, the above-obtained sample was subjected to battery evaluation by use of a single-cell-type battery evaluation apparatus employing the EC electrolytic solution. In the charging/discharging cycle test, the capacity and coulomb efficiency at the 1st cycle and the capacity at the 50th cycle were measured. The results are shown in Table 1.

### Comparative Example 2

A sample having no surface carbon layer was prepared. Specifically, there was prepared, as a sample, the carbonaceous powder employed in Example 1; i.e., carbonaceous powder, particles of the powder having an average volume-based particle size (D50) of 20 μm and an average roundness of 0.88. The ratio by area of crystalline carbon regions of the powder to amorphous carbon regions thereof was 80:20 as calculated from a bright-field image of the powder obtained by use of a transmission electron microscope. FIG. 2 shows a transmission electron micrograph (×25,000) of the sample. A laser Raman spectrum of the surface carbon layer of the sample was obtained. The ratio of the intensity of a peak at 1,360 cm⁻¹ in the spectrum to that of a peak at 1,580 cm⁻¹ in the spectrum; i.e., 1,580 cm⁻¹ peak intensity/1,360 cm⁻¹ peak intensity, was found to be 0.39.

In a manner similar to Example 1, the above-obtained sample was subjected to battery evaluation by use of a single-cell-type battery evaluation apparatus employing the EC electrolytic solution. In the charging/discharging cycle test, the capacity and coulomb efficiency at the 1st cycle and the capacity at the 50th cycle were measured. The results are shown in Table 1.

TABLE 1

| | Capacity (mAh/g) | Coulomb efficiency | Capacity (mAh/g) |
|---|---|---|---|
| Sample | (1st cycle) | (%) (1st cycle) | (50th cycle) |
| Ex. 1 | 355 | 93 | 352 |
| Ex. 2 | 352 | 93 | 352 |
| Ex. 3 | 350 | 92 | 350 |
| Ex. 4 | 353 | 93 | 351 |
| Comp. Ex. 1 | 330 | 90 | 325 |
| Comp. Ex. 2 | 350 | 89 | 310 |

### EFFECTS OF THE INVENTION

According to the present invention, when a carbon layer of high crystallinity is formed on the surface of a carbonaceous material serving as a nucleus, which carbon layer as observed under a transmission electron microscope has crystalline carbon regions and amorphous carbon regions in a bright-field image thereof, a carbon material suitable as a negative electrode material for a lithium ion secondary battery can be produced having a high discharging capacity and low irreversible capacity, and exhibiting excellent coulomb efficiency and excellent cycle characteristics. The carbon material production method of the present invention is advantageous from the viewpoints of production cost and mass productivity. The production method employs an easy-to-handle coating material and promotes improved safety.

While the invention has been described in detail and with reference to specific embodiments thereof, it will be apparent to one skilled in the art that various changes and modifications can be made therein without departing from the spirit and scope thereof.

This application is based on Japanese Patent Application No. P2002-374271 filed Dec. 25, 2002, incorporated herein by reference in its entirety.

What is claimed is:

1. A negative electrode material comprising carbonaceous powder serving as a nucleus, and a carbon layer formed on the surface of the powder, characterized in that the carbon layer, when observed under a transmission electron microscope, has crystalline carbon regions and amorphous carbon regions in a bright-field image thereof, and the ratio of the intensity of a peak at 1,360 cm⁻¹ in a laser Raman spectrum of the carbon layer to that of a peak at 1,580 cm⁻¹ in the spectrum is 0.3 or less.

2. The negative electrode material as claimed in claim 1, wherein the carbonaceous powder has crystalline carbon regions and amorphous carbon regions, and the ratio by area of crystalline carbon regions of the carbonaceous powder serving as a nucleus to amorphous carbon regions of the powder is 95 to 50:5 to 50 as calculated from a bright-field image of the powder obtained by use of a transmission electron microscope.

3. The negative electrode material as claimed in claim 1, wherein the ratio by area of the crystalline carbon regions of the carbon layer to the amorphous carbon regions of the layer is 99 to 60:1 to 40 as calculated from a bright-field image of the carbon layer obtained by use of a transmission electron microscope.

4. The negative electrode material as claimed in claim 1, wherein the size Lc10 f crystallites constituting the carbon layer as measured along the c-axis of the layer, and the size Lc2 of crystallites constituting the carbonaceous powder as measured along the c-axis of the powder, satisfy the relation represented by the following formula (1):
Lc1<Lc2 (1).

5. The negative electrode material as claimed in claim 1, wherein the size La10 f crystallites constituting the carbon layer as measured along the a-axis of the layer, and the size La2 of crystallites constituting the carbonaceous powder as measured along the a-axis of the powder, satisfy the relation represented by the following formula (2):
La1<La2 (2).

6. The negative electrode material as claimed in claim 1, wherein, in a bright-field image of the carbon layer obtained by use of a transmission electron microscope, the amorphous carbon regions are randomly dispersed in the crystalline carbon regions.

7. The negative electrode material as claimed in claim 1, wherein the carbon layer is formed by depositing a composition containing a phenolic resin, and a drying oil or a fatty acid derived therefrom onto carbonaceous powder serving as a nucleus in the presence of water, and thermally treating the composition-deposited powder in a non-oxidative atmosphere at a temperature of at least 2,500° C.

8. The negative electrode material as claimed in claim 1, wherein the carbon layer is formed by depositing a composition containing a phenolic resin, and a drying oil or a fatty acid derived therefrom onto carbonaceous powder serving as a nucleus in the presence of water, and thermally treating a mixture of the composition-deposited powder and vapor grown carbon fiber in a non-oxidative atmosphere at a temperature of at least 2,500° C.

9. The negative electrode material as claimed in claim 1, wherein the average roundness of particles of the carbonaceous powder serving as a nucleus is 0.85 to 0.99 as measured by use of a flow particle image analyzer.

10. The negative electrode material as claimed in claim 9, wherein the carbonaceous powder particles contain particles having a roundness of less than 0.90 as measured by use of a flow particle image analyzer in an amount of 2 to 20% by number of particles.

11. The negative electrode material as claimed in claim 8, wherein the amount of the vapor grown carbon fiber is 0.01 to 20 mass % of the mixture.

12. The negative electrode material as claimed in claim 8, wherein a fiber filament of said vapor grown carbon fiber includes a hollow space extending along its center axis, and having an outer diameter of 2 to 1,000 nm and an aspect ratio of 10 to 15,000.

13. The negative electrode material as claimed in claim 11, wherein the vapor grown carbon fiber is branched carbon fiber.

14. The negative electrode material as claimed in claim 11, wherein the vapor grown carbon fiber contains carbon having, at a (002) plane, an average interlayer distance (d₀₀₂) of 0.344 nm or less as measured by means of X-ray diffractometry.

15. The negative electrode material as claimed in claim 1, wherein said carbon layer formed on the surface of the carbonaceous powder serving as a nucleus is obtained by firing a composition, deposited on said carbonaceous powder, containing a polymer selected from the group consisting of a phenolic resin, a polyvinyl alcohol resin, a furan resin, a cellulose resin, a polystyrene resin, a polyimide resin, and an epoxy resin.

16. A method for producing a negative electrode material which comprises depositing a composition containing a polymer onto at least a portion of the surface of carbonaceous powder serving as a nucleus in the presence of water; mixing the resultant carbonaceous powder with vapor grown carbon fiber; and subsequently thermally treating, in a non-oxidative atmosphere, the carbonaceous powder onto which the polymer-containing composition has been deposited.

17. The method for producing a negative electrode material as claimed in claim 16, wherein the thermal treatment step comprises firing at a temperature of at least 2,500° C.

18. An electrode paste comprising a negative electrode material as claimed in claim 1, and a binder.

19. An electrode comprising a molded product of an electrode paste as claimed in claim 18.

20. A secondary battery comprising an electrode as claimed in claim 19.

21. The secondary battery as claimed in claim 20, which comprises a non-aqueous electrolytic solvent and an electrolyte, wherein the non-aqueous electrolytic solvent is at least one selected from the group consisting of ethylene carbonate, diethyl carbonate, dimethyl carbonate, methyl ethyl carbonate, and propylene carbonate.
